(19) United States
(12) Patent Application Publication
(10) Pub. No.: US 2008/0242752 A1
(43) Pub. Date: Oct. 2, 2008

(54) Polystyrene foams incorporating nanographite and HFC-134

(76) Inventors: Yadollah Delaviz, Lewis Center, OH (US); Raymond M. Breindel, Tallmadge, OH (US); Mitchell Z. Weekley, Tallmadge, OH (US); Roland R. Loh, Tallmadge, OH (US); Manoj K. Choudhary, Reynoldsburg, OH (US)

Correspondence Address: OWENS CORNING, 2790 COLUMBUS ROAD, GRANVILLE, OH, 43023, US

(21) Appl. No.: 11/729,157

(22) Filed: Mar. 28, 2007

(51) Int. Cl. C08J 9/00; C08F 14/00

(52) U.S. Cl. 521/79; 521/146

(57) ABSTRACT

Polymeric foam and polymeric foam products that contain a foamable polymer material, nanographite, and 1,1,2,2-tetrafluoroethane (HFC-134) are provided. Preferably, the foamable polymer material is an alkenyl aromatic polymer material. The foam is free of other conventional blowing agents typically utilized in preparing a foamed product. The nanographite is not chemically or surface modified and is preferably compounded in a polyethylene methyl acrylate copolymer (EMA), which is used both as a medium and a carrier for the nanographite. The nanographite may be compounded in the polymer in an amount up to 60% loading. In addition, the nanographite acts as a nucleating agent, R-value enhancer, infrared attenuating agent, lubricant, UV absorber, and process aid. The inventive foam composition produces extruded foams that have R-values that are equal to or better than conventional extruded foams produced with 1-chloro-1,1-difluoroethane (HCFC-142b). The foamed products are desirably made by a conventional extrusion process.

### TECHNICAL FIELD AND INDUSTRIAL APPLICABILITY OF THE INVENTION

The present invention relates generally to foam insulating products, and more particularly, to a polystyrene foam containing 1,1,2,2-tetrafluoroethane (HFC-134) and nanographite to increase insulating capability and decrease thermal conductivity

### BACKGROUND OF THE INVENTION

Foamed resinous structures are useful in a wide variety of applications such as thermal insulation, as insulating structural members, in cushions, as packaging, and as adsorbents. The usefulness of rigid foamed polymeric boards in a variety of applications is well-known. For example, rigid polymeric foam boards are used as insulating structural members in many applications.

Extruded foams are generally made by melting a polymer together with any desired additives-to create a polymer melt. A blowing agent is mixed with the polymer melt at an appropriate temperature and pressure to produce a foamable gel mixture. The foamable gel mixture is then cooled and extruded into a zone of reduced pressure, which results in a foaming of the gel and the formation of the desired extruded foam product.

Traditional blowing agents used for extruded foam products include chlorofluorocarbons (CFCs) and hydrochlorofluorocarbons (HCFCs). One of the advantages of both CFC and HCFC blowing agents is their high solubility in a polymer melt during the manufacturing process. Higher blowing agent solubility promotes a reduction in viscosity when the blowing agent is mixed with the polymer melt. In turn, lower viscosity leads to lower energy requirements for mixing. On the other hand, a major disadvantage to these traditional blowing agents is that an increasing number of governments worldwide have mandated the elimination of CFC and HCFC blowing agents due to growing environmental concerns. CFCs, and many other halocarbons, have come to be recognized as serious global environmental threats due to their ability to cause stratospheric ozone depletion and global warming. The ozone depletion and global warming impact of chemicals such as CFCs and HCFCs are measured by the ozone depletion potential (ODP) and global warming potential (GWP) respectively.

In view of the mandatory phase out of blowing agents with a high ODP and a high GWP, there has been a movement to replace the conventional blowing agents in favor of more environmentally friendly blowing agents, such as hydrofluorocarbons (HFCs) and CO₂ in insulating foam applications. Although HCFCs provide a superior thermal barrier compared to CO₂, the chlorine present in the HCFCs possess ozone depletion potential. Additionally, over time, the chlorofluorocarbon gas phase in the foam is released into the atmosphere, thereby reducing the insulative value of the foam and potentially contributing to the global warming potential. Further, each of these non-conventional blowing agents leads to a different cell size and morphology depending on the particular blowing agent chosen. Unfortunately, the cell sizes of the foam produced by these generally environmentally friendly blowing agents are too small to provide an acceptable insulative value to the foamed product and generally results in a higher density and a more costly product.

To reduce thermal conductivity and increase the insulative value of the foamed product, infrared attenuating agents (IAAs) such as carbon black, powdered amorphous carbon, graphite, and titanium dioxide have been used as fillers in polymeric foam products. The thermal conductivity, k, is defined as the ratio of the heat flow per unit cross-sectional to the temperature drop per thickness. The United States defines k by the unit of Formula (I):

$$\text{Formula (I):}$$

$$\frac{Btu \cdot in}{Hr \cdot {Ft}^{2} \cdot ° F .}$$

The metric unit is defined by Formula (II):

$$\text{Formula (II):}$$

$$\frac{W}{m \cdot k}$$

Reducing the thermal conductivity (k) maximizes the insulating capability (i.e., increases the R-value) for a given thickness. The heat transfer through an insulating material may occur through solid conductivity, gas conductivity, radiation, or convection. The total thermal resistance (R-value), is the measure of the resistance to heat transfer, and is determined by the Formula (III):

R=t/k; where t=thickness Formula (III):

The usefulness of rigid foamed polymeric boards in a variety of applications is well-known. For example, rigid polymeric foam boards are used as insulating structural members in many applications. It is desirable to improve the thermal conductivity without increasing the density, and/or the thickness of foam product.

Previously, there have been attempts in the art to utilize infrared attenuating agents to increase or maintain the thermal insulation value of the foam. Some examples of these foams are described below.

U.S. Pat. No. 6,417,240 to Park discloses foams prepared from a blend of a syndiotactic polypropylene (sPP resin) and a foamable thermoplastic polymer resin. It is asserted that the blended polymer foams are flexible, have a high distortion temperature, and exhibit increased dimensional stability over foams prepared from a thermoplastic resin alone. Thermoplastic resins for use in the foam include all types of thermoplastic polymers that are foamable by extrusion processes. Non limiting examples include flexible polyolefin resins, ethylene/vinyl acetate resins, and alkyl aromatic resins such as polystyrene. The blowing agents utilized in preparing the foam include all types of blowing agents including physical and chemical blowing agents. Examples include 1,1,1,2-tetrafluoroethane (HFC-134a), 1,1,2,2-tetrafluoroethane (HFC-134), and 1-chloro-1,1-difluoroethane (HCFC-142b). Optionally, the foams may further include an infrared absorber such as carbon black, graphite, or titanium dioxide to enhance insulating capabilities.

U.S. Patent Publication No. 2001/0036970 to Park teaches polymer foams that have a good balance of high sound absorption, low thermal conductivity, and generally low water absorption. The polymer foam matrix is preferably made of a thermoplastic foam that optionally contains a cell size enlarging agent, an antioxidant, carbon black, and/or flame retardant additives. A volatile organic compound such as isobutane is preferably used as a blowing agent. However, alternative blowing agents useful in making the foam include 1,1,1,2-tetrafluoroethane (HFC-134a), 1,1,2,2-tetrafluoroethane (HFC-134), and 1-chloro-1,1-difluoroethane (HCFC-142b). Thermoplastic resins suitable for use in the polymer foams include polystyrenes, polyolefin resins, and blends of ethylene-styrene interpolymer (ESI) resins with polyolefin resins. Various additives such as inorganic fillers, nucleating agents (e.g., talc), UV absorbers, processing aids, extrusion aids, and flame retardants may be incorporated into the foam. In addition, an infrared absorber such as carbon black, graphite, or titanium dioxide may be included in the foam to enhance thermal insulating capability.

U.S. Patent Publication No. 2001/0036970 to Loh, et al. discloses an extruded polystyrene foam that contains multi-layered nanographite as a process additive for improving the physical properties of the foam products. The nanographite is preferably chemically treated to introduce carboxyl and phenolic hydroxyl functional groups on the graphite edge. The rigid, closed cell, polymer foamed board is formed by an extruding process with the multilayered nanographite, at least one blowing agent, and other additives. The foam includes any material suitable to make polymer foams, which include thermoplastic materials such as polyolefins, polyvinylchloride, polycarbonates, polyetheramines, etc. A preferred thermoplastic polymer included in the foam is an alkenyl aromatic polymer material such as polystyrene. The blowing agents utilized in preparing the foam include all types of blowing agents including physical and chemical blowing agents. Examples include 1,1,1,2-tetrafluoroethane (HFC-134a), 1,1,2,2-tetrafluoroethane (HFC-134), and 1-chloro-1,1-difluoroethane (HCFC-142b). It is asserted that the foam exhibits improved thermal insulation (R-values).

Despite the previous attempts to utilize infrared attenuating agents to improve thermal insulative properties, there remains a need in the art to achieve an extruded polymer foam that maintains the positive physical properties of conventional extruded polystyrene foams and that provides a foam product with increased insulation value (R-value).

### SUMMARY OF THE INVENTION

It is an object of the present invention to provide a composition that includes a foamable polymer material, nanographite, and 1,1,2,2-tetrafluoroethane (HFC-134). The foam is free of other conventional blowing agents typically utilized in preparing a foamed product. In addition, the foam may be free of additives that are typically included in conventional foam compositions and/or foam products to impose desired properties or characteristics to the foam or foam products. Preferably, the foamable polymer material is an alkenyl aromatic polymer material, such as polystyrene. The nanographite is not chemically or surface modified and is desirably compounded in a polyethylene methyl acrylate copolymer (EMA), which is used both as a medium and a carrier for the nanographite. The nanographite acts as a nucleating agent, R-value enhancer, infrared attenuator, lubricant, UV absorber, process aid, and colorant. The nanographite acts as a nucleating agent and eliminates the need to include a conventional nucleating agent such as talc. The foamable polymer material may be present in the composition in an amount from about 80% to about 99% by dry weight of the total composition, the 1,1,2,2-tetrafluoroethane may be present in the composition in an amount from about 3.0 to about 12% by dry weight of the total composition, and the nanographite may be present in the composition in an amount from about 0.05 to about 5.0% by dry weight of the total composition.

It is another object of the present invention to provide a polymer foam insulative product that includes a shaped, extruded polymeric foam having a composition consisting of a foamable polymer material, 1,1,2,2-tetrafluoroethane as a blowing agent, and nanographite. The foamable polymer material is preferably alkenyl aromatic polymer material, such as polystyrene. The foam is a substantially closed cellular foam with an average density of about 1.35 lbs/ft³ to about 3.5 lbs/ft³ and a cell size of from about 50 microns to about 400 microns (0.050 mm to 0.40 mm), which makes the foam especially useful for thermal insulation. In addition, the closed cell structure helps to increase the R-value of the formed, foamed insulation product. The R-value per inch may be from about 4.5 to about 5.8. The foam products have insulation values that are equal to or better than conventional extruded foam products produced with 1-chloro-1,1-difluoroethane (HCFC-142b).

It is a further object of the present invention to provide a method of making a foamed product. Foamed products according to the present invention may be prepared by any method known to those of skill in the art, but are preferably made by a conventional extrusion process or batch process. In an extrusion process, the polymer (e.g., polystyrene), the non-modified nanographite (with or without being compounded in a polyethylene methyl acrylate copolymer), along with any additives, if desired, are heated to a first temperature sufficient to melt the polymer(s) and mixed to form a melted polymer material. The blowing agent, 1,1,2,2-tetrafluoroethane (HFC-134), is then added to the melted polymer material under a first pressure to generally disperse the blowing agent homogeneously in the melt polymer material and permit a thorough mixing of the blowing agent and melted polymer material while preventing a pre-foaming of the melted polymer material. The foamable gel is then cooled to a second temperature (i.e., the die melt temperature), and is extruded into a zone of reduced pressure (a second pressure), resulting in foaming of the gel and formation of the desired extruded foam product. The zone of reduced pressure is at a pressure lower than that in which the foamable gel is maintained prior to extrusion through the die. The lower pressure may be super-atmospheric, atmospheric, or sub-atmospheric (i.e., a vacuum), but is preferably at sub-atmospheric level.

The foamed products may be made by a batch process. In a batch process, discrete resin particles and the nanographite, such as granulated resin pellets, are suspended in a liquid medium. It is desirable that the resin pellets are substantially insoluble in the liquid medium to form a suspension medium (i.e., the liquid medium containing the resin pellets). In preferred embodiments, the liquid medium is water. The suspension medium is then impregnated with 1,1,2,2-tetrafluoroethane (HFC-134) by introducing the 1,1,2,2-tetrafluoroethane (HFC-134) into the liquid medium at an elevated pressure and temperature in an autoclave or other pressure vessel. The suspension medium is then cooled in an attempt to maintain a sufficient level of the blowing agent within the beads. These beads may then be charged into a mold, re-heated, and foamed into a pre-determined shape to form a final foamed product.

It is an advantage of the present invention that the nanographite acts as a nucleating agent and eliminates the need to include a conventional nucleating agent such as talc.

It is yet another advantage of the present invention that the nanographite foams of the present invention increase the aged thermal resistance (R-values) of the foam boards.

It is also an advantage of the present invention that the inventive composition produces extruded foam products that have insulation values that are equal to or better than conventional extruded foam products produced with 1-chloro-1,1-difluoroethane (HCFC-142b).

It is another advantage of the present invention that extruded foam products formed using 1,1,2,2-tetrafluoroethane (HFC-134) and nanographite utilize about 25 to about 30% less blowing agent by weight than extruded foam products formed with 1-chloro-1,1-difluoroethane (HCFC-142b).

It is a further advantage of the present invention that the 1,1,2,2-tetrafluoroethane (HFC-134) is highly soluble in the polymer melt, and, as a result, there is a reduction in the process die pressure compared to other hydrofluorocarbons such as HFC-134a, HFC-32, and HFC-227ea.

It is yet another advantage that the reduction in process die pressure caused by the use of 1,1,2,2-tetrafluoroethane (HFC-134) as the blowing agent increases the process operating window.

It is yet another advantage of the present invention that the nanographite assists in improving fire performance properties such as decreasing the flame spread, which helps to meet stringent fire requirements.

It is a feature of the present invention that the nanographite acts as a nucleating agent, an R-value enhancer, an infrared attenuator, a lubricant, a UV absorber, a process aid, and a colorant.

It is yet another feature of the present invention that the 1,1,2,2-tetrafluoroethane (HFC-134) is non-flammable and does not require a co-blowing agent.

It is yet another feature of the present invention that the nanographite reduces static and provides lubrication during the foaming process.

It is another feature of the present invention the foamable composition of the present invention has a low global warming potential and zero ozone depleting potential.

It is also a feature of the present invention that the inclusion of nanographite in the inventive composition improves the oxygen index value of the foam.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a graphical illustration of a comparison of the R-values and densities of extruded foam boards formed produced utilizing HCFC-142b and HFC-134;

FIG. 2 is a graphical illustration of the effect of nanographite on R-values of extruded foam boards produced utilizing 11 wt % HCFC-142b; and

FIG. 3 is a graphical illustration of the effect of nanographite on R-values of extruded foam boards produced utilizing 7.5 wt % HFC-134.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

The present invention relates to a polymeric foam and polymeric foam products, such as extruded or expanded polystyrene foams, that contain nanographite as an infrared attenuating agent and process additive and 1,1,2,2-tetrafluoroethane (HFC-134) as the blowing agent. In particular, the inventive foam contains a foamable polymer material, nanographite, and 1,1,2,2-tetrafluoroethane (HFC-134). The foam is free of other conventional blowing agents typically utilized in preparing a foamed product. In addition, the foam may be free of additives that are typically included in conventional foam compositions and/or foam products to impose desired properties or characteristics to the foam or foam products. The inventive foam composition produces extruded foams that have insulation values (R-values) that are equal to or better than conventional extruded foams produced with 1-chloro-1,1-difluoroethane (HCFC-142b). In particular, the foam composition produces rigid, closed cell, polymer foam boards prepared by an extruding process. The addition of nanographite improves thermal and mechanical properties as well fire performance properties of the final foamed product.

The foamable polymer material is the backbone of the formulation and provides strength, flexibility, toughness, and durability to the final product. The foamable polymer material is not particularly limited, and generally, any polymer capable of being foamed may be used as the foamable polymer in the resin mixture. The foamable polymer material may be thermoplastic or thermoset. The particular polymer material may be selected to provide sufficient mechanical strength and/or the process utilized to form final foamed polymer products. In addition, the foamable polymer material is preferably chemically stable, i.e., generally non-reactive, within the expected temperature range during formation and subsequent use in a polymeric foam. Non-limiting examples of suitable foamable polymer materials include alkenyl aromatic polymers, polyvinyl chloride (PVC), chlorinated polyvinyl chloride (CPVC), polyethylene, polypropylene, polycarbonates, polyisocyanurates, polyetherimides, polyamides, polyesters, polycarbonates, polymethylmethacrylate, polyurethanes, phenolics, polyolefins, styreneacrylonitrile, acrylonitrile butadiene styrene, acrylic/styrene/acrylonitrile block terpolymer (ASA), polysulfone, polyurethane, polyphenylenesulfide, acetal resins, polyamides, polyaramides, polyimides, polyacrylic acid esters, copolymers of ethylene and propylene, copolymers of styrene and butadiene, copolymers of vinylacetate and ethylene, rubber modified polymers, thermoplastic polymer blends, and combinations thereof. Suitable polyolefins include polyethylene and polypropylene, and ethylene copolymers.

Preferably, the foamable polymer material is an alkenyl aromatic polymer material. Suitable alkenyl aromatic polymer materials include alkenyl aromatic homopolymers and copolymers of alkenyl aromatic compounds and copolymerizable ethylenically unsaturated comonomers. In addition, the alkenyl aromatic polymer material may include minor proportions of non-alkenyl aromatic polymers. The alkenyl aromatic polymer material may be formed of one or more alkenyl aromatic homopolymers, one or more alkenyl aromatic copolymers, a blend of one or more of each of alkenyl aromatic homopolymers and copolymers, or blends thereof with a non-alkenyl aromatic polymer. Notwithstanding the components of the composition, the alkenyl aromatic polymer material may include greater than 50 and preferably greater than 70 weight percent alkenyl aromatic monomeric units. In a preferred embodiment of the invention, the alkenyl aromatic polymer material is formed entirely of alkenyl aromatic monomeric units.

Examples of alkenyl aromatic polymers include, but are not limited to, those alkenyl aromatic polymers derived from alkenyl aromatic compounds such as styrene, α-methylstyrene, ethylstyrene, vinyl benzene, vinyl toluene, chlorostyrene, and bromostyrene. A preferred alkenyl aromatic polymer is polystyrene. Minor amounts of monoethylenically unsaturated compounds such as C₂ to C₆ alkyl acids and esters, ionomeric derivatives, and C₂ to C₆ dienes may be copolymerized with alkenyl aromatic compounds. Non-limiting examples of copolymerizable compounds include acrylic acid, methacrylic acid, ethacrylic acid, maleic acid, itaconic acid, acrylonitrile, maleic anhydride, methyl acrylate, n-butyl acrylate, ethyl acrylate, isobutyl acrylate, methyl methacrylate, vinyl acetate, and butadiene. Preferably, the polymer(s) has a weight-average molecular weight from about 190,000 to about 270,000, and more preferably from 200,000 to 260,000. Recycled polymers having a weight-average-molecular weight from about 100,000 to about 180,000, preferably from about 124,000 to about 155,000 may also be utilized in the inventive composition.

The foamed products may be formed substantially of (e.g., greater than 95 percent), and most preferably, formed entirely of polystyrene. The foamable polymer material may be present in the composition in an amount from about 80% to about 99% by weight, preferably in an amount from about 90% to about 99% by weight. As used herein, the term “% by weight” is meant to indicate a percentage based on 100% total dry weight of the composition.

The properties of the extruded foam or foam product may be modified by the selection of the molecular weight of the polymer. For example, the preparation of lower density extruded foam products may be facilitated by using lower molecular weight polymers. On the other hand, the preparation of higher density extruded foam products may be facilitated by the use of higher molecular weight or higher viscosity resins.

The foam composition also contains nanographite. The nanographite can be multilayered by furnace high temperature expansion from acid-treated natural graphite or microwave heating expansion from moisture saturated natural graphite. Desirably, the nanographite is a multi-layered nanographite which has at least one dimension with a thickness less than about 100 nm. In some exemplary embodiments, the graphite may be mechanically treated such as by air jet milling to pulverize the nanographite particles. The pulverization of the particles ensures that the nanographite flake and other dimensions of the particles are less than about 20 microns, most likely less than about 5 microns.

The nanographite is not chemically or surface modified and is preferably compounded in a polyethylene methyl acrylate copolymer (EMA), which is used both as a medium and a carrier for the nanographite. Other possible carriers for the nanographite include polymer carriers such as, but not limited to, polymethyl methacrylate (PMMA), polystyrene, polyvinyl alcohol (PVOH), and polyvinyl acetate (PVA). The nanographite may be compounded in the polymer in an amount up to 60% loading. Desirably, the nanographite is compounded in the polymer in an amount from 15-60% loading, and more preferably from 20-40% loading. In at least one exemplary embodiment, the nanographite is compounded in EMA at 40% loading.

It is desirable that the nanographite be substantially evenly distributed throughout the foam. As used herein, the phrase “substantially evenly distributed” is meant to indicate that the substance (e.g., nanographite) is evenly distributed or nearly evenly distributed within the foam. The mixing temperature may be about 150° C. to about 300° C., preferably about 225° C. for EMA loading. A mixing time of about 0 to about 3 minutes, typically less than one minute for an EMA carrier containing 40 percent by weight nanographite, is desirable to effectively disperse the nanographite throughout the polymer. The mixing may be conducted by any standard method known in the art, such as by extrusion or compounding methods. Preferably, the components are mixed using a Banbury mixer.

The nanographite acts as a nucleating agent, R-value enhancer, infrared attenuator, lubricant, UV absorber, process aid, and colorant. It is to be appreciated that the presence of nanographite in the inventive foam eliminates the need for conventional nucleating agents such as calcium carbonate, barium stearate, talc, clay, titanium dioxide, silica, diatomaceous earth, and/or mixtures of citric acid and sodium bicarbonate. The nanographite is present in the foam composition in an amount from about 0.05 to about 5.0% by dry weight of the total composition, preferably in an amount from about 0.25 to about 3.5% by dry weight.

It is to be appreciated that although nanographite is preferred, it is within the purview of the invention to include alternate infrared attenuating agents (IAAs) in place of the nanographite with the expectation that such alternate infrared attenuating agents would produce similar or otherwise satisfactory, if not superior, results. Examples of such infrared attenuating agents that may alternately be utilized include, but are not limited to carbon black, granulated asphalt, milled glass, fiber glass strands, mica, black iron oxide, metal flakes such as aluminum flakes, and combinations thereof.

As discussed above, with the exception of 1,1,2,2-tetrafluoroethane (HFC-134), the inventive foam material is free of conventional blowing agents. Conventional blowing agents include inorganic agents, organic blowing agents and chemical blowing agents. Specific examples of inorganic blowing agents include carbon dioxide, nitrogen, argon, water, air, nitrogen, and helium. Conventional organic blowing agents include, but are not limited to, aliphatic hydrocarbons having 1-9 carbon atoms, aliphatic alcohols having 1-3 carbon atoms, and fully and partially halogenated aliphatic hydrocarbons having 14 carbon atoms. Aliphatic hydrocarbons include methane, ethane, propane, n-butane, isobutane, n-pentane, isopentane, neopentane, and dimethyl ether (t)ME). Aliphatic alcohols include methanol, ethanol, n-propanol, and isopropanol. Fully and partially halogenated aliphatic hydrocarbons include fluorocarbons, chlorocarbons, chlorofluorocarbons, and cyclopentane. Non-limiting examples of fluorocarbons include methyl fluoride, perfluoromethane, ethyl fluoride (HFC-161), ethyl fluoride, 1,1-difluoroethane (HFC-152a), 1,1,1-trifluoroethane (HFC-143a), 1,1,1,2-tetrafluoro-ethane (HFC-134a), pentafluoroethane (HFC-125), difluoromethane (HFC-32), perfluoroethane, 2,2-difluoropropane (HFC-272fb), 1,1,1-trifluoropropane (HFC-263fb), perfluoropropane, 1,1,1,3,3-pentafluorobutane (HFC-365mfc), 1,1,1,3,3-pentafluoropropane (HFC 245fa), 1,1,1,2,3,3,3-heptafluoropropane (HFC-227ea), dichloropropane, difluoropropane, perfluorobutane, and perfluorocyclobutane. Partially halogenated chlorocarbons and chlorofluorocarbons include methyl chloride, methylene chloride, ethyl chloride, 1,1,1-trichloroethane, 1,1-dichloro-1-fluoroethane (HCFC-141b), 1-chloro-1,1-difluoroethane (HCFC-142b), chlorodifluoromethane (HCFC-22), 1,1-dichloro-2,2,2-trifluoroethane (HCFC-123) and 1-chloro-1,2,2,2-tetrafluoroethane (HCFC-124), and the like. Fully halogenated chlorofluorocarbons include trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. Conventional chemical blowing agents include azodicarbonamide, azodiisobutyro-nitrile, benzenesulfonhydrazide, 4,4-oxybenzene sulfonyl-semicarbazide, p-toluene sulfonyl semi-carbazide, barium azodicarboxylate, and N,N′-dimethyl-N,N′-dinitrosoterephthalamide and trihydrazino triazine.

The blowing agent, 1,1,2,2-tetrafluoroethane (HFC-134), may be present in the composition in an amount from about 3.0 to about 12% by dry weight of the total composition. Preferably, the 1,1,2,2-tetrafluoroethane is present in the foamable composition an amount from about 6.0 to about 10.0% by weight.

Although the inventive foam composition is desirably free of any additives that are typically included in conventional foam applications to impose desired properties or characteristics to the foamable composition and/or to the final foamed product, additives such as UV stabilizers, UV absorbers, plasticizers, antioxidants, processing aids, extrusion aids, antistatic agents, stabilizers, flame retardants, pigments, dyes, and/or colorants may be added in small quantities to the foam composition in some exemplary embodiments. These optional additives may be included in amounts necessary to obtain desired characteristics of the foamable gel or resultant extruded foam products. In particular, the total amount of additives that may be present in the size composition may be from 0 to about 5.0% by dry weight of the total composition, and in some embodiments, the additives may be added in an amount from about 0.5 to about 3.8% by dry weight of the total composition. Preferably, optional additives are added to the resin mixture but may be added in alternative ways to the extruded foam manufacture process.

Foamed products according to the present invention may be prepared by any method known to those of skill in the art such as with an extruder (twin or single), a mixer, or a blender. Preferably, the foamed products are made by a conventional extrusion process or batch process. In an extrusion process, the polymer (e.g., polystyrene), the non-modified nanographite (with or without being compounded in a polyethylene methyl acrylate copolymer), along with any additives, if desired, are heated to a first temperature sufficient to melt the polymer(s) (i.e., the melt mixing temperature) and mixed to form a melted polymer material (i.e., a nanographite/polymer mixture). The melt mixing temperature must be sufficient to plastify or melt the polymer. Therefore, the melt mixing temperature is a temperature that is at or above the glass transition temperature or melting point of the polymer. In a preferred embodiment, the melt mixing temperature ranges from about 200 to about 250° C., and more preferably from about 220 to about 240° C., depending on the amount of nanographite present in the melted polymer material.

The blowing agent, 1,1,2,2-tetrafluoroethane (HFC-134), is then added to the melted polymer material under a first pressure to generally disperse the blowing agent homogeneously in the melt polymer material and permit a thorough mixing of the blowing agent and melted polymer material while preventing a pre-foaming of the melted polymer material. As the blowing agent is added to the polymer melt, the blowing agent becomes soluble, i.e. dissolves, in the polymer melt. The blowing agent plasticizes the polymer melt, which eases the processability of the system. Once the blowing agent is incorporated and thoroughly mixed with the melted polymer material, the resulting composition is typically referred to as a foamable gel. The die pressure should be sufficient to prevent pre-foaming of the foamable gel, and includes pressures ranging from about 45 to about 80 bars, most preferably about 50 to about 75 bars. Pre-foaming is the undesirable premature foaming of the foamable gel before extrusion into a zone of reduced pressure.

The foamable gel is then cooled to a second temperature (i.e., the die melt temperature), and is extruded into a zone of reduced pressure (a second pressure), resulting in foaming of the gel and formation of the desired extruded foam product. The zone of reduced pressure is at a pressure lower than that in which the foamable gel is maintained prior to extrusion through the die. The lower pressure may be super-atmospheric, atmospheric, or sub-atmospheric (i.e., a vacuum), but is preferably at sub-atmospheric level. It is to be appreciated that the die melt temperature is generally lower than the melt mix temperature to optimize the physical characteristics of the foamed product. Additionally, the die melt temperature is typically within 30° C. of the melt mix temperature. In a preferred embodiment, the die melt temperature is from about 110° C. to about 145° C., and most preferably from about 120 to about 140° C.

During foaming, multi-layered nanographite acts as a nucleator and lubricant as well as its slipping action makes the flow of the melted polymer in the extruder easier, and provides a smooth surface to the foam board. Further, the multi-layered nanographite reduces the amount of static present during the foaming process due to the increased electric conductivity of the skin of the nanographite polymer foam boards. In addition, the nanographite can be uniformly or nearly uniformly blended throughout the polymer extrusion process, resulting in a homogenous foam product.

Extruded foams have a cellular structure with cells defined by cell membranes and struts. Struts are formed at the intersection of the cell membranes, with the cell membranes covering interconnecting cellular windows between the struts. In the present invention, the inventive composition preferably produces a substantially closed cellular foam with an average density of about 1.35 lbs/ft³ to about 3.5 lbs/ft³, preferably from about 1.6 lbs/ft³ to about 2.6 lbs/ft³ and a cell size of from about 50 microns to about 400 microns (0.050 mm to 0.40 mm), which makes the foam especially useful for thermal insulation. It is to be appreciated that the phrase “substantially closed cell” is meant to indicate that the foam contains all closed cells or nearly all of the cells in the cellular structure are closed. It is desirable that not more than about 5.0% of the cells are open cells or otherwise “non-closed” cells. The closed cell structure helps to increase the R-value of a formed, foamed insulation product. The R-value per inch may be from about 4.5 to about 5.8. In a most preferred embodiment, the R-value per inch is between 4.9 and 5.8. It is to be appreciated that it is within the purview of the present invention to produce an open cell structure, although such an open cell structure is not a preferred embodiment.

Another aspect of the extruded inventive foams is that they possess a high level of dimensional stability. For example, the change in dimension in any direction is about 5% or less. In addition, the foam formed by the inventive composition is desirably monomodal and the cells have a relatively uniform average cell size. As used herein, the average cell size is an average of the cell sizes as determined in the X, Y and Z directions. In particular, the “X” direction is the direction of extrusion, the “Y” direction is the cross machine direction, and the “Z” direction is the thickness. In the present invention, the highest impact in cell enlargement is in the X and Y directions, which is desirable from an orientation and R-value perspective. The extruded inventive foam can be used to make insulation products such as rigid insulation boards, insulation foam, packaging products, cushioning products, roofing boards, and deck boards.

As discussed above, the foamed products may be made by a batch process. In a batch process, discrete resin particles and the nanographite, such as granulated resin pellets, are suspended in a liquid medium. It is desirable that the resin pellets are substantially insoluble in the liquid medium to form a suspension medium (i.e., the liquid medium containing the resin pellets). In preferred embodiments, the liquid medium is water. The suspension medium is then impregnated with 1,1,2,2-tetrafluoroethane (HFC-134) by introducing the 1,1,2,2-tetrafluoroethane (HFC-134) into the liquid medium at an elevated pressure and temperature in an autoclave or other pressure vessel. The suspension medium is then cooled in an attempt to maintain a sufficient level of the blowing agent within the beads. These beads may then be charged into a mold, re-heated, and foamed into a pre-determined shape to form a final foamed product.

There are numerous advantages of utilizing the composition of the present invention to form foam products. For example, the blowing agent utilized in the inventive formulation has a high solubility in the foamable polymer (e.g., polystyrene). Therefore, little, if any, processing issues such as insufficient die pressure (which results in pre-foaming) arise during the production of the foamed product. In addition, the inventive composition contains only one blowing agent, HFC-134, and does not require a co-blowing agent like many conventional HFC-containing foams. Additionally, the non-flammability of HFC-134 eliminates capital requirements related to the installation of equipment suitable to handle flammable blowing agents. Also, 1,1,2,2-tetrafluoroethane (HFC-134) has a zero ozone depleting potential and a global warming potential less than HCFC-142b. Therefore, the inventive foam creates less environmental concerns than foams produced utilizing HCFC-142b as a blowing agent. Further, the nanographite is added to the polymer melt in a conventional fashion. Thus, there is no need to modify existing equipment or change the manufacturing lines to produce a foam or foam product utilizing the inventive composition.

Further it has been surprisingly discovered that the use of 1,1,2,2-tetrafluoroethane (HFC-134) and nanographite produces foams that possess superior thermal insulating properties. For example, the inventive foam produces extruded foam products that have insulation values that are equal to or better than conventional extruded foam products produced with 1-chloro-1,1-difluoroethane (HCFC-142b).

Having generally described this invention, a further understanding can be obtained by reference to certain specific examples illustrated below which are provided for purposes of illustration only and are not intended to be all inclusive or limiting unless otherwise specified.

### EXAMPLES

In the following examples, all foam boards are extruded polystyrene foam boards. The rigid foam boards were prepared by a twin screw extruder with a flat die and shaper plate and were extruded into an atmospheric or sub-atmospheric zone.

### Example 1

### Comparison of Foam Board R-values For HCFC-142b and HFC-134 Containing No Nanographite

Compositions containing polystyrene, either 1,1,2,2-tetrafluoroethane (HFC-134) or 1-chloro-1,1-difluoroethane (HCFC-142b), and talc as depicted in Table 1 were formed according to the extrusion method described in detail above. In particular, the polystyrene and talc were heated to a melt mixing temperature of 150° C.-180° C. to form a melt polymer material. 1,1,2,2-tetrafluoroethane was then mixed into the polymer melt at a first pressure from 210-230 bars to generally disperse the blowing agent homogeneously in the melt polymer material and form a foamable gel. The foamable gel was then cooled to a temperature from 125° C.-135° C. The foamable gel was extruded in a twin screw extruder and through a die to a zone of reduced pressure (14.0 psi absolute-5.0 psi absolute) to produce the rigid foam boards. As used in the examples, the phrase “% by weight” is the % by dry weight of the component based on the total composition. The process conditions are set forth in Table 2.

TABLE 1
Compositions of Foamed Boards

| | Blowing | Blowing Agent | Talc | Polystyrene |
|---|---|---|---|---|
| | Agent | (% by weight) | (% by weight) | (% by weight) |
| Control | HCFC- | 11 | 0.5 | 98.8 |
| | 142b | | | |
| Sample 1 | HFC-134 | 7.5 | 0.25 | 98.8 |
| Sample 2 | HFC-134 | 9.0 | 0.25 | 99 |

TABLE 2
Process Conditions

| | |
|---|---|
| Extruder Pressure, psi | 1950–2400 |
| Melt Mixing Temperature (° C.) | 150–180 |
| Die Melt Temperature (° C.) | 117–123 |
| Die Pressure, psi | 790–950 |
| Line Speed, ft/min | 6–9.5 |
| Throughput, kg/hr | 160 |
| Die Gap, mm | 1.8–2.0 |
| Vacuum, inch Hg | 0 to 16 |

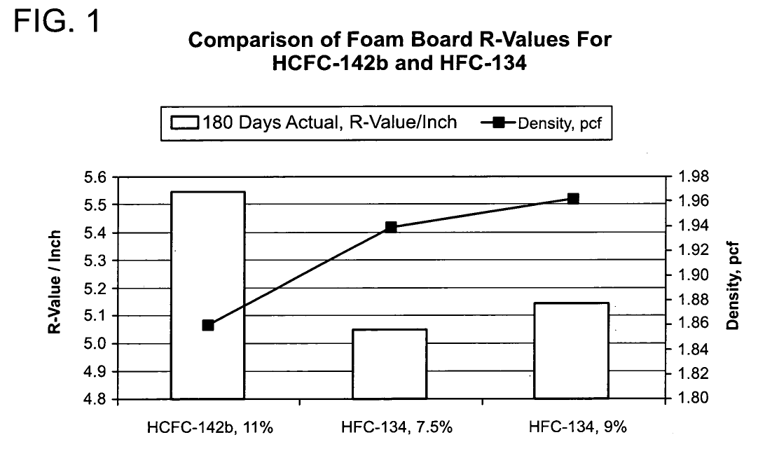

The rigid, extruded foamed boards were then aged for 180 days under ambient conditions. The R-value/inch was measured according to the procedures set forth in ASTM C-518. The density was measured by weighing the foamed board and dividing the total weight (mass) by the total volume of the board. The results are set forth in Table 3 and in FIG. 1.

TABLE 3
Aged R-values and Density

| | | | 180 days | |
|---|---|---|---|---|
| | Blowing | Blowing Agent | (actual) | Density |
| | Agent | (% by weight) | R-value/inch | (lbs/ft³) |
| Control | HCFC-142b | 11 | 5.55 | 1.86 |
| Sample 1 | HFC-134 | 7.5 | 5.05 | 1.94 |
| Sample 2 | HFC-134 | 9.0 | 5.15 | 1.96 |

Example 1 was conducted to determine the effect of the amount of 1,1,2,2-tetrafluoroethane (HFC-134) on the aged R-values compared to the current marketed product which utilizes 11% 1-chloro-1,1-difluoroethane (HCFC-142b) as the blowing agent. As shown in Table 3 and in FIG. 1, although Samples 1 and 2 had R-values less than the Control (11% 1-chloro-1,1-difluoroethane (HCFC-142b)), increasing the percentage of HFC-134 in the foam composition increased the R-value of the foam board. Using higher levels of HFC-134, i.e., 9.0 wt % vs. 7.5 wt %, improved the 180 days R-value/inch (actual) from 5.05 to 5.15 with nearly identical densities. It is known in the art that increasing the density of a foam increases the R-value of the foamed product. Because the densities remained nearly the same when 7.5 wt % and 9.0 wt % of HFC-134 were used to prepare the foam board, the increase in R-value is due to the increase in the amount of HFC-134 contained in the composition. Thus, The increase in 1,1,2,2-tetrafluoroethane (HFC-134) from 7.5 wt % to 9.0 wt % resulted in an approximate 2% improvement in R-value.

In addition, it can be seen that the control sample containing HCFC-142b had a lower density but a higher R-value than inventive Samples 1 and 2 containing HFC-134. Generally, a higher density correlates to an increased R-value, but in this case, the increased R-value is due to the lower thermal conductivity of the gas and the higher amount of blowing agent used (11% HCFC-142b).

### Example 2

### Effect of Nanographite on R-Values for Foamed Boards Formed with 11 wt % HCFC-142b

Compositions containing polystyrene, 1-chloro-1,1-difluoroethane (HCFC-142b), and nanographite as depicted in Table 4 were formed according to the extrusion method described in detail above. In particular, the polystyrene and nanographite were heated a melt mixing temperature of 150° C.-180° C. to form a melt polymer material. 1-chloro-1,1-difluoroethane was then mixed into the polymer melt at a first pressure from 210-230 bars to generally disperse the 1-chloro-1,1-difluoroethane homogeneously in the melt polymer material and form a foamable gel. The foamable gel was then cooled to a temperature from 125° C.-135° C. (the die melt temperature). The foamable gel was extruded in a twin screw extruder and through a die to a zone of reduced pressure (14.0 psi absolute-5.0 psi absolute) to produce the rigid foam boards. The process conditions are set forth in Table 4.

TABLE 4
Compositions of Foamed Boards

| | Blowing | Blowing Agent | Nanographite | Polystyrene |
|---|---|---|---|---|
| | Agent | (% by weight) | (% by weight) | (% by weight) |
| Sample 1 | HCFC- | 11 | 0 | 98.5 |
| | 142b | | | |
| Sample 2 | HCFC- | 11 | 1.0 | 96.3 |
| | 142b | | | |
| Sample 3 | HCFC- | 11 | 2.0 | 93.8 |
| | 142b | | | |

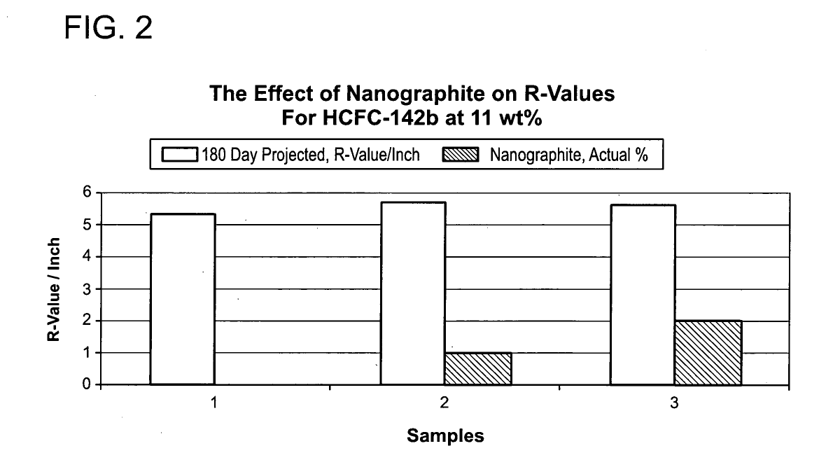

The rigid, extruded foamed boards were then aged for 180 days under ambient conditions. The actual R-value/inch was measured at 180 days according to the procedures set forth in ASTM C-518. The density was measured by weighing the foamed board and dividing the total weight (mass) by the total volume of the board. The results are set forth in Table 5 and in FIG. 2.

TABLE 5
Actual Aged R-values and Density

| | | 180 days | | |
|---|---|---|---|---|
| | | (Actual) | Nanographite | |
| | HCFC-142 | R- | (Actual) | Density |
| | (% by weight) | value/inch | (% by weight) | (lbs/ft³) |
| Sample 1 | 11 | 5.35 | 0 | 1.55 |
| Sample 2 | 11 | 5.71 | 1 | 1.61 |
| Sample 3 | 11 | 5.68 | 2 | 1.60 |

Example 2 was conducted to determine the effects nanographite quantities in the foam composition on the actual aged R-values of the conventional extruded foam boards containing 11% HCFC-142b. As shown from above samples, the addition of 1.0% nanographite caused an increase in the actual R-value/inch from 5.35 at 0 wt % nanographite addition to 5.7 (1.0 wt % nanographite addition), as well as in increase in the density from 1.55 lbs/ft³ to 1.61 lbs/ft³. Additional amounts of nanographite added to the foam composition did not result in a substantial change in the R-values, as is demonstrated by Samples 2-3 in Table 5 and FIG. 2. It was concluded from these results that the addition of nanographite to the foam board produced with HCFC-142b enhanced the insulation values (R-values) of the extruded polystyrene boards. It was further determined from the results shown in Table 4 and FIG. 2 that the optimal amount of nanographite in foaming processing needed to improve the R-value of extruded foam boards was from 0 to 1.0% nanographite. It was noted that the additional amounts of nanographite added in Sample 3 did not result in a substantial increase in R-value.

### Example 3

### Effects of Nanographite on R-Values for Foamed Boards Formed with 7.5 wt % HFC-134

Compositions containing polystyrene, 1,1,2,2-tetrafluoroethane (HFC-134), and nanographite as depicted in Table 5 were formed according to the extrusion method described in detail above. In particular, the polystyrene and nanographite were heated a melt mixing temperature of 150° C.-180° C. to form a melt polymer material. 1,1,2,2-tetrafluoroethane (HFC-134) was then mixed into the polymer melt at a first pressure from 210-230 bars to generally disperse the 1,1,2,2-tetrafluoroethane homogeneously in the melt polymer material and form a foamable gel. The foamable gel was then cooled to a temperature from 125° C.-135° C. (the die melt temperature). The foamable gel was extruded in a twin screw extruder and through a die to a zone of reduced pressure (14.0 psi absolute-5.0 psi absolute) to produce the rigid foam boards. The process conditions are set forth in Table 6.

TABLE 6
Compositions of Foamed Boards

| | Blowing | Blowing Agent | Nanographite | Polystyrene |
|---|---|---|---|---|
| | Agent | (% by weight) | (% by weight) | (% by weight) |
| Sample 1 | HFC-134 | 7.5 | 0 | 98.8 |
| Sample 2 | HFC-134 | 7.5 | 1.0 | 96.5 |

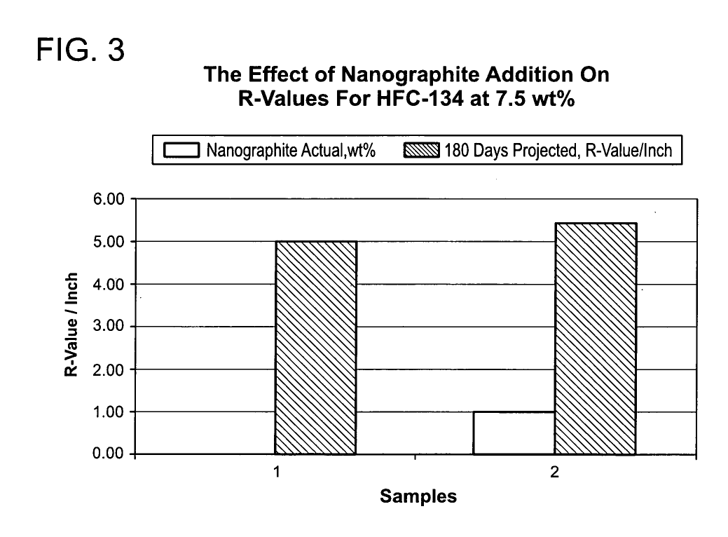

The rigid, extruded foamed boards were then aged for 180 days under ambient conditions. The actual R-value/inch was measured at 180 days according to the procedures set forth in ASTM C-518. The density was measured by weighing the foamed board and dividing the total weight (mass) by the total volume of the board. The results are set forth in Table 7 and in FIG. 3.

TABLE 7
Actual Aged R-values and Density

| | | 180 days | | |
|---|---|---|---|---|
| | | (Actual) | Nanographite | |
| | HCFC-134 | R- | (Actual) | Density |
| | (% by weight) | value/inch | (% by weight) | (lbs/ft³) |
| Sample 1 | 7.5 | 5.0 | 0 | 2.07 |
| Sample 2 | 7.5 | 5.41 | 1.0 | 2.1 |

It has been surprisingly discovered that the use of 1,1,2,2-tetrafluoroethane (HFC-134) and nanographite produces foams and foam products that possess superior thermal insulating properties. The results summarized in Table 7 and in FIG. 3 demonstrate the advantage of adding low amounts of nanographite (≦1.0 wt %) to enhance insulation values (R-values) and lower the thermal conductivity of the extruded polystyrene foam board. As shown in Table 7, the addition of 1.0 wt % nanographite to the foam composition improved the actual R-value from 5.0 to 5.41, an approximate 8% improvement in R-value.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A composition for forming a thermoplastic polymer foam comprising:
a foamable polymer material;
1,1,2,2-tetrafluoroethane as a blowing agent; and
nanographite,
wherein said composition is free of other blowing agents typically utilized in preparing polymer foams.

2. The composition of claim 1, wherein said composition is free of additives typically included in conventional foam compositions to impose desired properties or characteristics to said foam compositions.

3. The composition of claim 1, wherein said foamable polymer material is an alkenyl aromatic polymer material.

4. The composition of claim 3, wherein said foamable polymer material is selected from polystyrene, polyvinyl chloride, chlorinated polyvinyl chloride, polyethylene, polypropylene, polycarbonates, polyisocyanurates, polyetherimides, polyamides, polyesters, polycarbonates, polymethylmethacrylate, polyurethanes, phenolics, polyolefins, styreneacrylonitrile, acrylonitrile butadiene styrene, acrylic/styrene/acrylonitrile block terpolymer, polysulfone, polyurethane, polyphenylenesulfide, acetal resins, polyamides, polyaramides, polyimides, polyacrylic acid esters, copolymers of ethylene and propylene, copolymers of styrene and butadiene, copolymers of vinylacetate and ethylene, rubber modified polymers, thermoplastic polymer blends and combinations thereof.

5. The composition of claim 1, wherein said foamable polymer material is present in said composition in an amount from about 80% to about 99% by dry weight of the total composition, said 1,1,2,2-tetrafluoroethane is present in said composition in an amount from about 3.0 to about 12% by dry weight of the total composition, and said nanographite is present in said composition in an amount from about 0.05 to about 5.0% by dry weight of the total composition.

6. The composition of claim 1, wherein said nanographite not chemically or surface modified.

7. The composition of claim 6, wherein said nanographite is compounded in a carrier selected from polyethylene methyl acrylate copolymer, polymethyl methacrylate, polystyrene, polyvinyl alcohol and polyvinyl acetate.

8. The composition of claim 1, wherein said composition further comprises additives typically included in conventional foam compositions to impose desired properties or characteristics to said foam compositions.

9. A polymer foam insulative product comprising:
a shaped, extruded polymeric foam having a composition consisting of:
a foamable polymer material;
1,1,2,2-tetrafluoroethane as a blowing agent; and
nanographite.

10. The polymer foam insulative product of claim 9, wherein said foamable polymer material is an alkenyl aromatic polymer material.

11. The polymer foam insulative product of claim 10, wherein said extruded polymeric foam has a density from about 1.35 lbs/ft³ to about 3.5 lbs/ft³.

12. The polymer foam insulative product of claim 10, wherein said extruded polymeric foam has a substantially closed cell structure.

13. The polymer foam insulative product of claim 10, wherein said extruded polymeric foam has an R-value greater than or equal to an R-value of an extruded polymeric foam produced with 1-chloro-1,1-difluoroethane as a blowing agent.

14. The polymer foam insulative product of claim 10, wherein the R-value of said extruded polymeric foam is between about 4.5 to about 5.8.

15. The polymer foam insulative product of claim 9, wherein said insulative product is a rigid foam board.

16. A method of forming a foamed insulation product comprising:
compounding nanographite in a polymer carrier in an amount up to 60% loading of said nanographite to form a compounded nanographite; and
forming a foamed product by a process selected from an extruding process and a batch process.

17. The method of claim 16, wherein said forming step comprises an extruding process, said extruding process including:
heating said compounded nanographite and a foamable polymer material to a first temperature sufficient to melt said foamable polymer material and form a melted mixture;
adding 1,1,2,2-tetrafluoroethane to said melted mixture under a first pressure to form a foamable gel;
cooling said foamable gel to a second temperature, said second temperature being less than said first temperature, to form a cooled foamable gel; and
extruding said cooled foamable gel at a second pressure to form said foamed insulation product.

18. The method of claim 16, wherein said foamable polymer material is an alkenyl aromatic polymer material.

19. The method of claim 18, wherein said polymer carrier is selected from polyethylene methyl acrylate copolymer, polymethyl methacrylate, polystyrene, polyvinyl alcohol and polyvinyl acetate.

20. The method of claim 16, wherein said foamed insulation product has an R-value greater than or equal to an R-value of a foamed insulation product produced with 1-chloro-1,1-difluoroethane as a blowing agent.
